(19) United States
(12) Patent Application Publication
(10) Pub. No.: US 2007/0039019 A1
(43) Pub. Date: Feb. 15, 2007

(54) System and method for multiple channel recall

(76) Inventor: Shawn J. Collier, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 11/203,450

(22) Filed: Aug. 12, 2005

(51) Int. Cl. H04N 5/445; H04B 1/18

(52) U.S. Cl. 725/37; 455/154.1

(57) ABSTRACT

Presented herein are system(s), method(s), and apparatus for providing a channel recall with a plurality of channels. In one embodiment, there is presented a method for providing content. The method comprises selecting content from a first channel, until receiving a recall signal; receiving the recall signal; switching from selecting content from the first channel to selecting content from a second channel after receiving the recall signal; selecting content from the second channel until receiving another recall signal; receiving the another recall signal; and switching from selecting content from the second channel to selecting content from a third channel after receiving the recall signal.

### RELATED APPLICATIONS

Not Applicable

### FEDERALLY SPONSORED RESEARCH OR DEVELOPMENT

Not Applicable

### MICROFICHE/COPYRIGHT REFERENCE

Not Applicable

### BACKGROUND OF THE INVENTION

A user can select channels for display on a display device in a variety of ways. For example, the user can provide an identifier identifying the channel through selection of appropriate buttons on a control panel. However, modern cable and satellite television providers provide, several hundreds, if not thousands of different programming channels to select from. The channels are often identified by three or more digits. Where a user wishes to briefly view the content from a number of channels before selecting a channel, known as channel surfing, it may be inconvenient for the user to provide the channel identifier for each of the number of channels.

Another way that a user can select channels is with an up and down channel selection button. In an alphabetical or numerical channel ordering scheme, the up or down channel selection button selects the next channel in the ordering scheme from the currently viewed channel. For example, in a numerical channel-ordering scheme, where channel #314 is displayed, the up channel selection button may cause a switch to channel #315. The down channel selection button may cause a switch to channel #313. The up/down channel function advantageously allows the user to channel surf, while pressing only a single key to traverse the channels.

However, the resulting channels from the up/down channel selections are dependent on the currently displayed channel. Where the channels that the user wishes to briefly view are not proximate with respect to each other in the channel-ordering scheme, use of the up/down channel selection may be inconvenient. For example, where the user wishes to briefly view channels #315 and #207 before selecting a channel, the use of the up/down channel button may be inconvenient.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Presented herein are system(s), method(s), and apparatus for a multiple channel recall function, substantially as shown in and/or described in connection with at least one of the figures, as set forth more completely in the claims.

These and other advantages and novel features of the present invention, as well as illustrated embodiments thereof will be more fully understood from the following description and drawings.

### BRIEF DESCRIPTION OF THE SEVERAL VIEWS OF THE DRAWINGS

FIG. 1 is a timing diagram for providing content in accordance with an embodiment of the present invention;

FIG. 2 is a flow diagram for providing content in accordance with an embodiment of the present invention;

FIG. 3 is a block diagram of an exemplary system for providing content in accordance with an embodiment of the present invention;

FIG. 4 is a block diagram of an exemplary controller in accordance with an embodiment of the present invention;

FIG. 5 is a block diagram of an exemplary controller in accordance with an embodiment of the present invention;

FIG. 6 is a flow diagram for adding channels to a channel recall in accordance with one embodiment of the present invention;

FIG. 7 is a flow diagram for adding channels to a channel recall in accordance with another embodiment of the present invention; and

FIG. 8 is a block diagram of an exemplary remote control in accordance with an embodiment of the present invention.

### DETAILED DESCRIPTION OF THE INVENTION

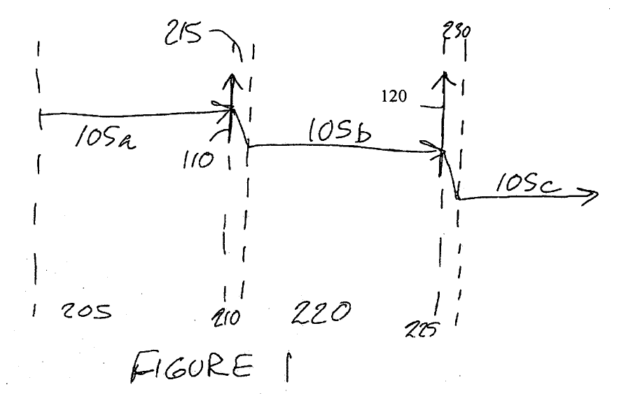

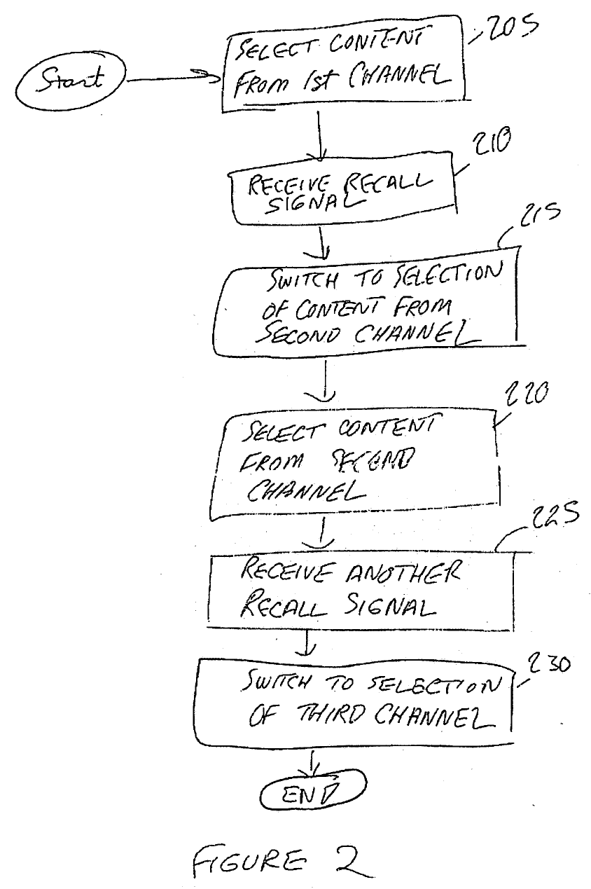

Referring now to FIG. 1, there is illustrated a timing diagram for providing content in accordance with an embodiment of the present invention. FIG. 1 will be described with reference to FIG. 2. FIG. 2 is a flow diagram for providing content in accordance with an embodiment of the present invention.

At 205, content from a first channel is selected. The term channel shall refer to a logical communication path over a shared or multiplexed media. The shared or multiplexed media can comprise, for example, a radio frequency band, a wired connection, or an optical communication link. The channel can comprise a channel in, for example, a frequency division multiple access scheme (FDMA), a time divisional multiple access scheme (TDMA), or a code division multiple access (CDMA) scheme. Additionally, the channels can include radio, television, cable, or satellite channels.

The content from the first channel 105a is selected until receiving a recall signal 110. The recall signal 110 is a signal that provides a command to select a previously designated channel. The previously selected channel is not identified in the recall signal. This is advantageous because a user can initiate selection of the previously designated channel selection by pressing only a single button on a control panel, such as a remote control. Additionally, unlike a channel up or channel down, the previously designated channel can be any channel that is available for selection, and can be determined without knowledge of the presently selected channel.

In certain embodiments, the previously selected channel can be the most recently viewed channel prior to the current channel. Upon another recall signal, the previously selected channel can be the second most recently viewed channel prior to viewing the current channel. Upon a third initiation of the recall signal, the previously selected channel can be the third most recently viewed channel prior to viewing the current channel.

Alternatively, a number of channels can be designated by the user. The channels can form a circular queue, wherein successive recall signals select channels by traversing the circular queue.

At 210, the recall signal is received. At 215, selection of content from the first channel is switched to selection of content from a second channel 105b after receiving the recall signal 110. Content from the second channel 110 is selected at 220 until another recall signal 120 is received at 225. After receiving the recall signal 120 at 225, at 230, selection of content from the second channel 105b is switched to selection of content from a third channel 105c.

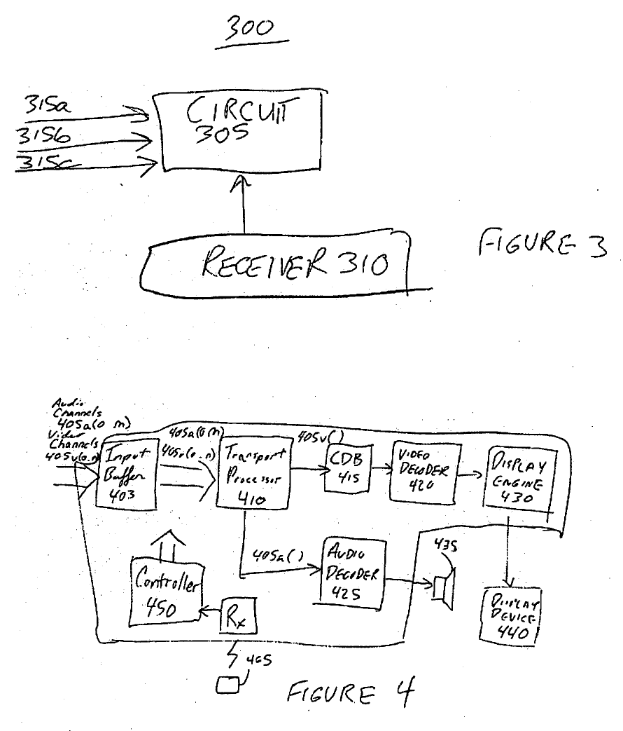

Referring now to FIG. 3, there is illustrated a block diagram of an exemplary system 300 for providing content. The system 300 comprises a circuit 305 and a receiver 310. The receiver 310 is capable of receiving signals corresponding to user commands. These signals can include channel recall functions. The signals can be infrared signals, radio signals, or electrical signals.

The circuit 305 receives content from a plurality of channels 315. The plurality of channels 315 comprises a first 315a, second 315b, and third channel 315c. The circuit 305 can select content from a particular one of the channels in a variety of ways. For example, the circuit 305 can comprise a tuner that is tuned to a particular frequency corresponding to a selected channel. Alternatively, the circuit 305 can comprise a demodulator that demodulates the content from the selected channel.

The circuit 305 selects content from a first channel 315a, until the receiver 310 receives the recall signal. Responsive thereto, the circuit 305 switches from selecting content from the first channel 315a to selecting content from a second channel after the receiver receives the recall signal, selecting content from the second channel until the receiver receives the another recall signal, and switching from providing content from the second channel to selecting content from a third channel after the receiver receives the recall signal.

In certain embodiments of the present invention, content from the first, second, and third channel can be transmitted in data packets. For example, in a digital cable broadcast, the video data from a plurality of channels is compressed, packetized, multiplexed, and transmitted over a coaxial cable to subscribers. In a digital satellite broadcast, the video data is transmitted over a wireless satellite link to subscribers. A decoder system receives the packets carrying content from the first, second, and third channel, and provides the content from at least one of the channels to the user. In certain embodiments, the circuit 305 can comprise a transport processor, a video decoder, a display engine, and an audio decoder 425.

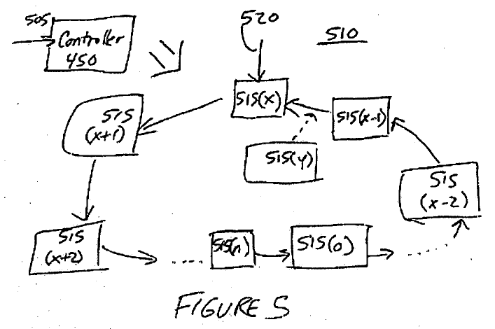

Referring now to FIG. 4, there is illustrated a block diagram of an exemplary decoder system in accordance with an embodiment of the present invention. The decoder system 400 comprises an input buffer 403, a transport processor 410, a video decoder 415, a display engine 420, and an audio decoder 425.

The decoder system 400 receives data packets carrying content from any number of audio 405a (0 . . . m) and video channels 405v (0 . . . n). An input buffer 403 stores the packets. A transport processor 410 can select packets carrying content from any selected video channels 405v( ) and any selected audio channels 405a( ). The transport processor 410 writes the content from the packets carrying the content from the selected video channel 405v( ) to a compressed data buffer 415. The video decoder 420 decompresses the content from the compressed data buffer 415. The display engine 430 provides the decompressed content to a display device 440 for display.

The transport processor 410 provides the content from the selected audio channel to the audio decoder 425. The audio decoder 425 decompresses the content from the selected audio channel and provides the decompressed content to a speaker 435.

The transport processor 410, video decoder 420, display engine 430, and audio decoder 425 can be slaves under the control of a controller 450. The controller 450 receives signals via a receiver Rx from a control panel 460 that can be operated by a user. The control panel 460 receives a command from a user and transmits a corresponding signal 465 to the receiver Rx. The signal can comprise, for example, an infrared signal, a radio signal, or an electronic signal.

The receiver 460 provides a signal to the controller 450. The controller 450 commands the transport processor 410, video decoder 420, display engine 430, and audio decoder 425 accordingly. The controller 450 is equipped to command the transport processor 410 to select particular the packets carrying content from particular video channels 405v( ) and audio channels 405a( ).

A user can select channels in a variety of ways. For example, the user can provide an identifier identifying the channel through selection of appropriate buttons on the control panel 460. However, modern cable and satellite television providers provide several hundreds, if not thousands of different programming channels to select from. The channels are often identified by three or more digits. Where a user wishes to briefly view the content from a number of channels before selecting a channel, known as channel surfing, it may be inconvenient for the user to provide the channel identifier for each of the number of channels.

Another way that a user can select channels is with an up and down channel selection button. In an alphabetical or numerical channel ordering scheme, the up or down channel selection button selects the next channel in the ordering scheme from the currently viewed channel. For example, in a numerical channel-ordering scheme, where channel #314 is displayed, the up channel selection button may cause a switch to channel #315. The down channel selection button may cause a switch to channel #313. The up/down channel function advantageously allows the user to channel surf, while pressing only a single key to traverse the channels.

However, the resulting channels from the up/down channel selections are dependent on the currently displayed channel. Where the channels that the user wishes to briefly view are not proximate with respect to each other in the channel-ordering scheme, use of the up/down channel selection may be inconvenient. For example, where the user wishes to briefly view channels #315 and #207 before selecting a channel, the use of the up/down channel button may be inconvenient.

Another way that a user may select channels is with a recall function. The recall function causes a previously designated channel to be selected. The previously designated channels can be maintained in a circular queue. Receipt of recall signals by the controller 450 via the receiver Rx, causes the controller 450 to select channels by traversing the circular queue.

In certain embodiments of the present invention, the previously selected channel can be the most recently viewed channel prior to the current channel. Upon another recall signal, the previously selected channel can be the second most recently viewed channel prior to viewing the current channel. Upon a third initiation of the recall signal, the previously selected channel can be the third most recently viewed channel prior to viewing the current channel.

Alternatively, a number of channels can be designated by the user. The channels can form a circular queue, wherein successive recall signals select channels by traversing the circular queue.

It is also noted that more than one video channel 405v( ) can be provided. For example, a number of display devices have what is known as a picture in picture PIP feature. The PIP feature allows the video content of another video channel 405v( ) to be displayed in a small portion of the display. The recall signals can initial channel changes on either the main picture or the PIP. Additionally, separate previously designated channels can exist for the main picture and the PIP. In certain embodiments of the present invention, the transport processor 410, video decoder 420 and display engine 430 can select, decompress, and provide the content from each of the video channels. Alternatively, separate transport processor 410, video decoder. 420, and display engine 430 can be associated with each of the video channels.

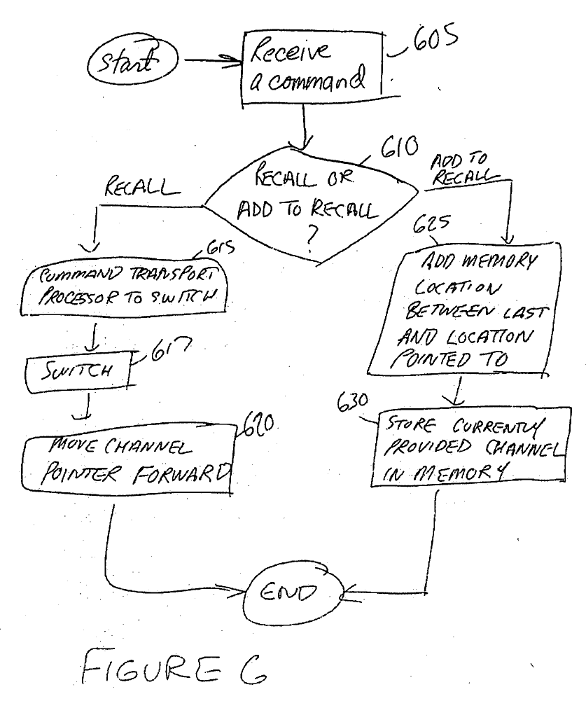

Referring now to FIG. 5, there is illustrated a block diagram of an exemplary controller 450 in accordance with an embodiment of the present invention. The controller 450 comprises an input 505. The controller 450 operates a circular queue 510. The circular queue 510 can have any number of memory locations 515(0 . . . n). Each memory location 515 stores an identifier identifying an audio channel 405a( ), video channel 405v( ), audio and video channel pair 405a( )/405v( ). Additionally, a video channel identifier 405v( ) may identify a corresponding audio channel 405a( ).

A channel pointer 520 points to a particular memory location 515, e.g., memory location 515(x), that stores the channel(s) 405a( )/405v( ) to switch to when a recall signal is received. When a recall signal is received, the channel pointer 520 points to the next memory location 515(x+1) in the circular queue 510.

The number of memory locations 515 in the circular queue 510 can be set in a number of ways. A graphical user interface provided by the controller 450 to allow the user to configure various features of the decoder system 400 may allow the user to set the number of memory locations 515 in he circular queue 510. Additionally, the graphical user interface may also allow the user to populate the circular queue 510.

Alternatively, each time the user switches from previous channel(s) to subsequent channel(s), either manually, or by use of the up/down channel, identifiers of the previous channel(s) are stored in the circular queue, if not already there. The previous channel(s) are stored in the last location 515(x−1) of the circular queue, and the channel pointer 520 is set to point to location 515(x−1).

In another embodiment, the control panel 460 may include a special button, or a combination of buttons thereon, that transmit a signal to the receiver Rx. The signal provides a command to the controller 450 to add another memory location 515(y) between the last location 515(x−1) and the current location 515(x) in the circular queue 510, and store identifier(s) of the currently provided channel(s) 405v( )/405a( ) in memory location 515(y).

In certain embodiments, the circular queue 510 can comprise a register-based memory forming a portion of the controller 450. In other embodiments of the present invention, the circular queue 510 can comprise memory that is separate from the controller 450.

Referring now to FIG. 6, there is illustrated a flow diagram for providing the content in accordance with an embodiment of the present invention. At 605, the controller 450 receives a command. At 610, a determination is made whether the command received during 605 is a recall command from a recall signal or an add to recall command from an add to recall signal.

If at 610, the command is a recall command from a recall signal.! at 615 the controller 450 commands the transport processor 410 to switch to selecting content from the channel(s) identified by the contents of the memory location 515, e.g., 515(x) identified by the channel pointer 520. At 617, the transport processor 410 switches. At 620, the channel pointer 520 moves forward into the circular queue 510 to point at memory location 515(x+1).

If at 610, the command is an add to recall command from an add to recall signal, the controller 450 adds (at 625) a memory location 515(y) between the last memory location 515(x−1) and the memory location pointed to by the channel pointer 520, memory location 515(x). At 630, the currently provided channel(s) are stored in the memory location 515(y).

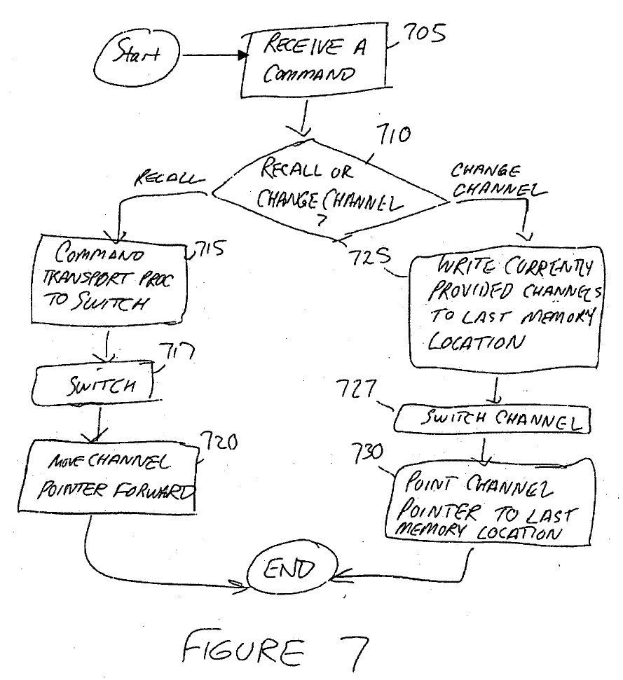

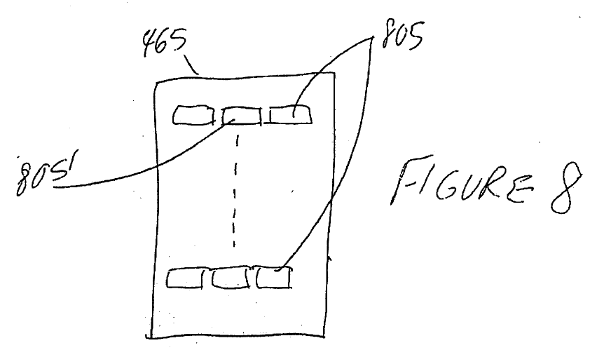

Referring now to FIG. 7, there is illustrated a flow diagram for displaying content in accordance with another embodiment of the present invention. At 705, the controller 450 receives a command. At 710, a determination is made whether the command received during 705 is a recall command from a recall signal or a change channel command.

If at 710, the command is a recall command from a recall signal, at 715 the controller 450 commands the transport processor 410 to switch to selecting content from the channel(s) identified by the contents of the memory location 515, e.g., 515(x) identified by the channel pointer 520. At 717, the transport processor 410 switches. At 720, the channel pointer 520 moves forward into the circular queue 510 to point at memory location 515(x+1).

If at 710, the command is change channel command, the controller 450 writes (at 725) the currently displayed channel (prior to the channel change) to the last memory location, e.g., memory location 515(x−1). At 727, the transport processor switches the channel. At 730, the channel pointer 520 points to the last memory location 515(x−1).

Referring now to FIG. 8, there is illustrated a block diagram of an exemplary control panel 465 in accordance with an embodiment of the present invention. The control panel 465 comprises a plurality of buttons 805. Depressing a particular one of the buttons 805′ by a user causes the control panel 465 to transmit a signal to a receiver Rx commanding a controller 450 to place the currently provided channel(s) into the circular queue 510.

The embodiments described herein may be implemented as a board level product, as a single chip, application specific integrated circuit (ASIC), or with varying levels of the system integrated with other portions of the system as separate components. Alternatively, if a commercially available processor is available as an ASIC core or logic block, then the commercially available processor can be implemented as part of an ASIC device wherein certain aspects of the present invention are implemented as firmware.

The degree of integration may primarily be determined by the speed and cost considerations. Because of the sophisticated nature of modern processors, it is possible to utilize a commercially available processor, which may be implemented external to an ASIC implementation.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for providing content, said method comprising:
selecting content from a first channel, until receiving a recall signal;
receiving the recall signal;.
switching from selecting content from the first channel to selecting content from a second channel after receiving the recall signal;
selecting content from the second channel until receiving another recall signal;
receiving the another recall signal; and
switching from selecting content from the second channel to selecting content from a third channel after receiving the recall signal.

2. The method of claim 1, wherein the content from the first channel, second channel, and third channel is multiplexed onto a wired communication link.

3. The method of claim 1, wherein the content from the first channel, second channel, and third channel is multiplexed onto a radio frequency band.

4. The method of claim 1, wherein the content comprises audio data.

5. The method of claim 1, wherein the content comprises video data.

6. The method of claim 1, further comprising:
selecting content from the third channel until receiving an additional recall signal; and
receiving the additional recall signal; and
switching from selecting the content from the third channel to selecting content from the fourth channel, after receiving the additional recall signal.

7. A system for providing content, said system comprising:
a receiver for receiving a recall signal, and another recall signal;
a circuit for selecting content from a first channel, until the receiver receives the recall signal, switching from selecting content from the first channel to selecting content from a second channel after the receiver receives the recall signal, selecting content from the second channel until the receiver receives the another recall signal, and switching from providing content from the second channel to selecting content from a third channel after the receiver receives the recall signal.

8. The system of claim 7, wherein the circuit comprises a transport processor.

9. The system of claim 7, wherein the circuit further comprises:
a decoder for decoding content from the first channel, until the receiver receives the recall signal, switching from decoding the content from the first channel to decoding the content from the second channel after the receiver receives the recall signal, decoding the content from the second channel until the receiver receives the another recall signal, and switching from decoding the content from the second channel to decoding content from a third channel after the receiver receives the recall signal.

10. The system of claim 7, wherein the content comprises video data, said circuit further comprising:
a display engine for providing video data from the first channel for display until the receiver receives the recall signal, switching from providing the video data from the first channel for display to providing the video data from the second channel for display, providing the video data from the second channel for display until the receiver receives the another recall signal, switching from providing the video data from the second channel for display to providing video data from the third channel for display after the receiver receives the another recall signal.

11. The system of claim 7, wherein the content comprises audio data.

12. The system of claim 7, wherein the first channel, second channel, and third channel are multiplexed onto a wired communication link.

13. The system of claim 7, wherein the first source, second source, and third source are multiplexed onto a radio frequency band.
